(19) United States
(12) Patent Application Publication
(10) Pub. No.: US 2024/0420096 A1
(43) Pub. Date: Dec. 19, 2024

(54) Closed-Loop Recycling System

(71) Applicants: COLGATE-PALMOLIVE COMPANY, New York, NY (US); MASSACHUSETTS INSTITUTE OF TECHNOLOGY, Cambridge, MA (US)

(72) Inventors: Bruce CUMMINGS, New York, NY (US); Eva Maria PONCE CUETO, Brookline, MA (US); Suzanne E. GREENE, Zurich (CH); Saikat BANERJEE, Waltham, MA (US)

(73) Assignees: COLGATE-PALMOLIVE COMPANY, New York, NY (US); MASSACHUSETTS INSTITUTE OF TECHNOLOGY, Cambridge, MA (US)

(21) Appl. No.: 18/704,187

(22) PCT Filed: Sep. 20, 2022
(86) PCT No.: PCT/US22/76695

§ 371 Date: Apr. 24, 2024

Related U.S. Application Data
(60) Provisional application No. 63/271,540, filed on Oct. 25, 2021.

(51) Int. Cl. G06Q 10/30; G06Q 10/083; G06Q 30/0207

(52) U.S. Cl. CPC G06Q 10/30; G06Q 10/083; G06Q 30/0207

(57) ABSTRACT

A system comprising a processor and a non-transitory computer-readable medium communicatively coupled to the processor is provided. The medium stores instructions configured to cause the processor to perform operations including receiving, from a user, a search request comprising one or more keywords related to a desired item, determining that the user is a participant in a closed-loop recycling program based on a user setting, identifying, based on the determination and the keywords, one or more item results, at least one qualifying result of the one or more item results having a packaging meeting a predetermined level of recyclability, and providing to the user in a prioritized manner, the at least one qualifying result.

### FIELD OF THE DISCLOSURE

The present disclosure relates to recycling systems and more particularly, to a closed-loop recycling system configured to maximize the amount of recycled material while minimizing consumer confusion and improving efficiency that reduces the cost of recycling materials.

### BACKGROUND OF THE DISCLOSURE

Based on concern for the environment, the importance of recycling as a means of reducing the amount of waste added to the environment, e.g., via burning, burying, etc., has increased dramatically in recent years. While many consumers would like to contribute to the global effort by practicing recycling, not all consumers have the ability to do so. For example, some jurisdictions and/or waste handlers do not offer a recycling service, and some consumers find the task of sorting the recyclable materials too tedious or difficult to follow through with their desire to help.

A typical recycling process on the consumer side may involve purchase of a product by a consumer, unpacking of the primary product, disposal of the secondary packaging, use of the product, and subsequent disposal of the primary product container (also considered primary packaging). At each of the disposal steps, a consumer may attempt to determine what portion of the material comprised by the to-be-disposed material is able to be recycled. While some materials may be clearly recycled and labeled as such, others may present limited to no markings regarding recyclability, and the consumer may question whether a package or material may be recyclable at all.

A typical recycling process on the recycling center side may involve collection of material from consumers during a typical waste collection, shipment to a recycling center, and sorting, by mechanical and human means to select desired recyclable material. A recycling center may employ any number of people tasked with monitoring the material along the line prior to reaching the recycling point, and with removing material and items that are not recyclable and/or that are not as desirable for recycling.

Thus, under current recycling systems many items are not recycled at all, despite their being provided to a recycling center. For example, items that are too small (e.g., lip balm containers) and/or possible contamination risks to the recycling stream may be simply removed from the recycling line and sent to landfills or incinerators. Further, certain items in the recycling line may be unidentifiable by personnel charged with making a final decision as to whether the items remain in the recycling pool or are removed and sent to landfills or incinerators.

U.S. Pat. No. 9,794,321 discloses a system, method, and a tag for mapping tagged objects to context-aware applications.

### SUMMARY OF THE DISCLOSURE

The present inventor has recognized that it is desirable to simplify and technically improve the recycling experience for both the consumer desiring to contribute to the global effort in waste reduction, as well as for recycling centers charged with handling the recycling tasks, while preferably generating sufficient revenue to exceed costs of operating the center, while also maintaining material value.

According to embodiments of the present disclosure, a system is provided. The system includes a processor and a non-transitory computer-readable medium communicatively coupled to the processor and storing instructions. The instructions are configured to cause the processor to perform operations including receiving, from a user, a search request comprising one or more keywords related to a desired item, determining that the user is a participant in a closed-loop recycling program based on a user setting, identifying, based on the determination and the keywords, one or more item results, at least one qualifying result of the one or more item results having a packaging meeting a predetermined level of recyclability, and providing to the user in a prioritized manner, the at least one qualifying result.

By providing such a system, a user desiring to participate in a closed-loop recycling system and thereby to focus primarily on items meeting recyclability requirements for such a system, may be provided with preferred choices during a shopping experience. The user may feel more comfortable and derive additional happiness from the ability to choose products that contribute to improvement in the global environment.

The instructions may further cause the processor to perform operations including, receiving, from the user, a first order comprising one or more selected items from the at least one qualifying result, and coordinating receiving of the packaging associated with the one or more selected items from the user.

Participation in the closed-loop recycling program may be determined based on a user preference stored in a database accessible by the processor.

The receiving of the packaging may be performed during a delivery of a second order received from the user.

The predetermined level of recyclability may range between 80 and 100 percent.

The instructions may further cause the processor to perform operations including tracking a quantity of recyclable packaging associated with the one or more selected items delivered to the user, measuring a quantity of material collected during delivery of the second order, and when the measured quantity of material exceeds the quantity of recyclable packaging delivered to the user by a predetermined threshold, requesting information regarding the measured quantity from the user.

The instructions may further cause the processor to perform operations including, when a user exceeds the predetermined threshold over greater than a predetermined number of collections and/or when no information is received in response to the request, prohibiting the user from participating in the closed-loop recycling program for a predetermined amount of time.

The instructions may further cause the processor to perform operations including enabling a user to exclusively view item results having packaging meeting the predetermined level of recyclability.

The instructions may further cause the processor to perform operations including providing to the user information indicating at least one of the tracked quantity, the measured quantity, a recycled amount, and an environmental impact based on the tracked quantity and/or the measured quantity.

The instructions may further cause the processor to perform operations including matching the user with one or more incentives for participating in the closed-loop recycling program based at least on the measured quantity of material.

The incentives may be selected from at least one of a monetary incentive, a priority incentive, and a recognition incentive.

According to further embodiments of the disclosure, a digital recycling center management system for a recycling center is provided. The system includes a conveyor configured to convey a plurality of objects from a loading point to an exit point, at least a portion of the plurality of objects comprising packaging having a predetermined level of recyclability and having been collected from a consumer, an object identification system comprising at least one optical capture device, the object identification system being configured to identify each object of the plurality of objects based on physical characteristics of each object and to issue an instruction based on the identification, an object removal system configured to remove identified objects from the conveyor and to place a removed object in a corresponding receptacle based on the instruction from the object identification system, an inflow monitor configured to measure an inflow of packaging materials on the conveyor, and an outflow monitor configured to measure a quantity of packaging materials remaining on the after object removal is completed, wherein the object identification system is configured to compare one or more captured images of an object to one or more images in a recyclable object image database and determine the issued instruction according to the identified object.

By providing a recycling center management system according to such embodiments, recycling for both a user and a digital recycling center is facilitated at least by reducing or even eliminating questions regarding what may be recycled and what should be discarded. Because the management system and a user may accurately identify recyclable packaging based on its physical characteristics (e.g., size, shape, color, trademark markings, etc.) and not based on special informational markings such as barcodes or material indicators, the task of sorting and recycling becomes more accurate and easier to perform.

The object identification system may further comprise a neural network component.

The neural network component of the object identification system may be trained based on at least one of the inflow of packaging materials and the quantity of packaging materials remaining on the conveyor after object removal is completed.

The corresponding receptacle may correspond to at least one of a material category and a material recyclability level.

The outflow monitor may be configured to issue a notification when the measured quantity exceeds a predetermined value.

Upon receiving the notification, the object removal system may operate under a contingency plan that mitigates an amount of outflow waste.

The system may further include a buffer located remotely from the recycling center, including a collection receptacle configured to collect and track a second inflow of packaging materials, a processor, and a non-transitory computer-readable medium communicatively coupled to the processor and storing instructions that when executed by the processor cause the processor to perform operations comprising, notifying the digital recycling center management system when a quantity of the collected packaging materials at the buffer is approaching and/or has exceeded a predetermined value.

The buffer may be located at a third-party merchant site.

According to still further embodiments, a method for facilitating closed-loop recycling is provided. The method includes receiving, from a user, a search request comprising one or more keywords related to a desired item, determining that the user is a participant in a closed-loop recycling program, identifying, based on the determination and the keywords, one or more item results, at least one qualifying result of the one or more item results having a packaging meeting a predetermined level of recyclability, providing, to the user in a prioritized manner, the at least one qualifying result, receiving, from the user, a first order comprising one or more selected items from the at least one qualifying result, collecting the packaging associated with the one or more selected items, identifying, by at least one optical capture device, a recyclable packaging from the collected packaging based on at least one of a shape and a logo present in an image, wherein the identifying comprises comparing one or more captured images of recyclable packaging to one or more images in a recyclable object image database, removing, by a removal system, the identified recyclable packaging and placing the identified recyclable packaging in a corresponding receptacle based on the identifying, and recycling the contents of the corresponding receptacle in a manner suitable for a category of the identified recyclable packaging.

The predetermined level of recyclability may be 100 percent.

The category may be based on a material from which the identified recyclable packaging is fabricated.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1A is high-level schematic depiction of a closed-loop recycling system according to embodiments of the present disclosure;

FIG. 1B is a high-level schematic depiction of an alternative closed-loop recycling system according to further embodiments of the present disclosure;

FIG. 2 is a flowchart depicting an exemplary process carried out by one or more computer devices to enable a closed-loop recycling system according to embodiments of the present disclosure;

FIG. 3 shows an exemplary user interface for prioritizing search results based on a recyclability level associated with an item;

FIG. 4 is a schematic diagram highlighting features of a digital recycling center according to embodiments of the present disclosure;

FIG. 5 is a flowchart depicting an exemplary process carried out by the hardware components of the digital recycling center of FIG. 4;

FIG. 6 is another schematic diagram highlighting alternative features of a closed-loop recycling system according to further embodiments of the present disclosure; and

FIG. 7 illustrates an exemplary computing device 700 that may be specifically configured to perform one or more of the processes described herein.

### DESCRIPTION OF THE EMBODIMENTS

Reference will now be made in detail to the present exemplary embodiments of the disclosure, examples of which are illustrated in the accompanying drawings. Wherever possible, the same reference numbers will be used throughout the drawings to refer to the same or like parts.

Embodiments of the present disclosure may facilitate an ecosystem in which up to 100 percent of materials used for packaging of products are both recyclable and recycled. Further, because up to 100 percent of the materials received by a user may be recyclable, confusion for a user desiring to participate in such a system is eliminated. The term “recycled” as used herein is not intended to refer to reuse of an item in its unaltered, original form, but instead refers to a process whereby the item is first transformed to a first state (e.g., to a raw material), and subsequently reformed into a second state (e.g., a new item).

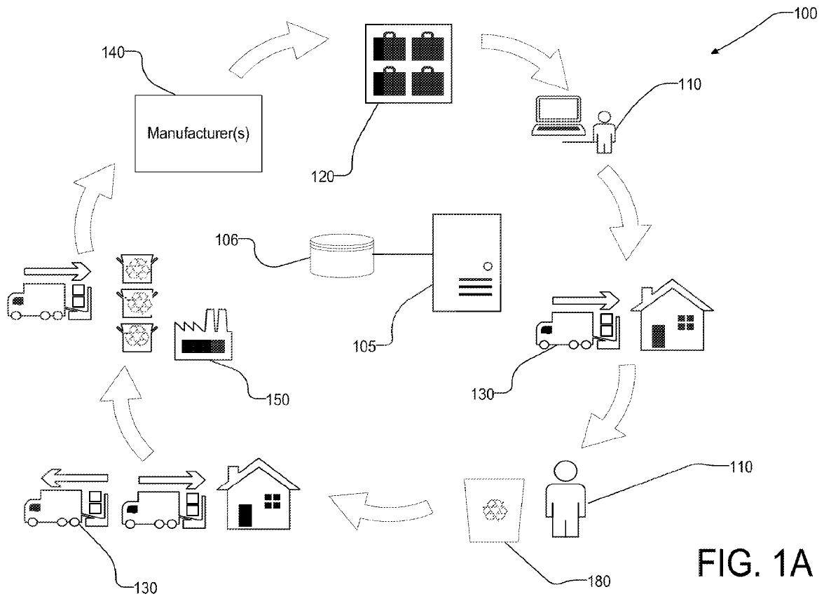

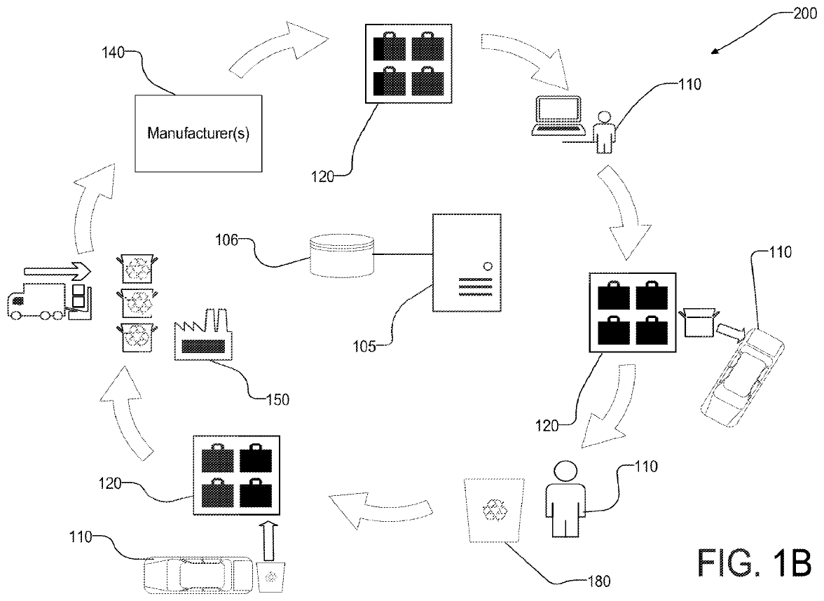

FIG. 1A is high level schematic depiction of an illustrative closed-loop recycling system 100 according to embodiments of the present disclosure. Participants in the closed-loop recycling system may include, for example, a user 110, a merchant 120, a carrier 130, one or more manufacturers 140, and a digital recycling center 150, among others. A server 105 may be communicatively connected to one or more of the participants by providing one or more computing interfaces via a network (not shown), for example, application programming interfaces (“API”) and/or graphical user interfaces (“GUI”), among others.

Server 105 may be implemented by any suitable computing device having communicative capabilities, for example, via a local area network (LAN), the internet, mobile connection (e.g., 4G, LTE, etc.), or combinations thereof, among others. Server 105 may be in communication with a database 106, the database being configured to store information related to product items and associated packaging qualifying for inclusion in closed-loop recycling system 100. Such information may include physical characteristics of the product and packaging, for example, packaging material composition, recyclability of the packaging material, packaging shape, packaging size, packaging color(s), designs, shapes, writing, and/or trademarks present on the packaging, etc.

Server 105 may be configured to perform various tasks related to closed-loop recycling system 100, for example, receiving search requests, orders, and profile management requests from a user 110, and coordinating delivery and pickup of items from users 110 (who may place the items in a collection bin 180), manufacturers 140, merchants 120, etc. by the carrier 130, among others. Server 105 may therefore maintain or establish intermittently communicative connections with participants of closed-loop recycling system 100 in order to perform such tasks.

In addition server 105 may be configured to access database 106 in order to provide and perform the functionality desired to implement in closed-loop recycling system 100. Database 106 may comprise any suitable means for storing data, such as, for example, a relational database management system (RDBMS), an object database, a flat file database, a spreadsheet database, combinations thereof, etc. Database 106 may include various types of information related to product items that qualify for inclusion in closed-loop recycling system 100. For example, database 106 may store product item pictures (e.g., digital images), descriptions, prices, available quantities, etc. Database 106 may also store information related to physical characteristics of each product item and its associated packaging, for example, size, dimensions, color, shape, trademarks, markings, etc.

Database 106 may also store information related to each participant in closed-loop recycling system 100. For example, database 106 may store user profiles, merchant profiles, manufacturer profiles, carrier profiles, etc. Each profile may include information related to participation in closed-loop recycling system 100, such as, for example, location information, preferences, storage volume capabilities, etc.

One of skill in the art will understand that while server 105 and database 106 are shown as single entities in the figures, more than one server 105 and database 106 may be implemented and tasks distributed across multiple servers 105 and/or databases 106 in order to facilitate operation of closed-loop recycling system 100. Additional functionality associated with server 105 and database 106 will be discussed in greater detail below.

User 110 may be a typical consumer and may desire to reduce the amount of waste generated and sent to a landfill, incinerated, or otherwise added to the global waste inventory. User 110 may, therefore, desire to participate in a closed-loop recycling program provided by one or more merchants 120 with the goal of purchasing and using items having packaging meeting a threshold level of recyclability (e.g., 80 percent, 90 percent, 100 percent, or the like).

User 110 may become a participant of a closed-loop recycling program in any suitable manner, for example, by indicating a preference online (e.g., via a checkbox or radio button) in their account profile at one or more merchants 120 for items qualifying for inclusion in the closed-loop recycling program. Upon selecting the preference for closed-loop recycling, user 110 may automatically become a participant in the closed-loop recycling program. The user's profile (e.g., stored in the database 106) may then be updated to indicate participation.

Alternatively, or in addition, an approval process may be implemented whereby a user 110 may submit or otherwise indicate a desire to participate in the closed-loop recycling program. For example, user 110 may complete an application (e.g., online, in-store, etc.) and submit the application for review by an administrator. Once approved, the user may be added to the closed-loop recycling program and the user's profile created and/or updated accordingly.

A similar application and approval process may also be implemented for allowing participation of merchants 120 and/or brand owners (e.g., manufacturers 140) in the closed loop-recycling programs described herein. For example, each merchant 140 may be required to apply for entrance to the program, and thereby agree to adhere to rules and standards set within the program. Failure to do so may result in removal from the closed-loop recycling program.

Merchant 120 may be an existing or newly created merchant, operating with an online and/or a brick-and-mortar presence. Merchant 120 may agree to participate, or otherwise agree to make available for acquisition items qualifying for inclusion in closed-loop recycling system 100. Items qualifying for inclusion in closed-loop recycling system 100 may be items having packaging meeting a predetermined level of recyclability. The term “packaging” as used herein shall be understood to include any portion of non-consumable, container materials associated with the item, including, for example, shipping containers, shipping container fill material, tubes, cans, canisters, boxes, jars, applicators, wrappers, jugs, bottles, caps, etc. For example, a lip-balm tube, a plastic milk jug, glass jars, a cardboard box, a blister pack with backing card, and plastic toothbrush container, etc. shall be considered to fall within the scope of the term packaging. These examples are not intended to be limiting.

The term “level of recyclability” as used herein shall be understood to refer to a quantity represented as a percentage corresponding to a weight or volume of the packaging that may be recycled. In other words, and as an example, a level of recyclability of 100 percent shall be understood to mean that all of the packaging associated with an item is recyclable. In another example, a level of recyclability of 80 percent shall be understood to mean that at least 80 percent of the packaging associated with an item is recyclable. For purposes of the present disclosure, a level of recyclability for items qualifying for inclusion in closed-loop recycling system 100 ranges between 80 and 100 percent, but one of skill will understand that lower levels of recyclability may be implemented without departing from the scope of the present disclosure.

Merchant 120 may provide one or more interfaces to users 110 for purposes of conducting commerce related to items to be sold by merchant 120 to one or more users 110. For example, merchant 120 may provide a web-based interface via server 105 enabling a user 110 to search, browse, and/or select items offered for sale by merchant 120 on a computing device from any suitable location (e.g., a home office). Such an interface may be suitable for use on any computing device, for example, a home computer, a laptop computer, a mobile phone, a tablet, a kiosk, etc.

Merchant 120 may also provide, for example, an interface present within a brick-and-mortar shop (e.g., a kiosk) enabling a user 110 to search, browse, and/or select items offered for sale within the store. One of skill in the art will understand that any suitable location may be considered for purposes of providing such an interface.

Merchant 120 may be communicatively connected to server 105, and according to some embodiments, merchant 120 may host at least one of server 105 and database 106 at a location associated with merchant 120 and/or at for example, a data center (not shown). Servers 105 may be configured to provide the merchant's interface, thus enabling user 110 to search, browse, and select items for purchase, as well as to provide information related to items qualifying for inclusion in the closed-loop recycling system 100.

According to some embodiments, the interface may be configured to provide the user 110 with, among others, images, descriptions, material compositions, recyclability levels, and other desirable information related to items available for purchase from merchant 120. For example, in response to a keyword search request, server 105 may access database 106 for information used to provide description, material composition, and recyclability information, among others, for at least a portion of the items available for purchase from merchant 120. Server 105 may also combine information related to other aspects of items for purchase (e.g., price, shipping weight, etc.) with information related to recyclability and composition for purposes of creating an item result list in response to the user search request keywords.

Manufacturer 140 may be any product manufacturer agreeing to participate in and adhere to the practices implemented by the closed-loop recycling system 100. For example, manufacturer 140 may be a provider of personal care items such a toothpaste, soaps, lotions, etc., or any other product item for purchase by user 110 and thus may agree that any packaging manufactured by manufacturer 140 and associated with the personal care items shall meet the threshold level of recyclability established by the system (e.g., 80-100 percent).

According to some embodiments, manufacturer 140 may manufacture both a product or item and a package for the product or item. Alternatively, a first manufacturer 140 may produce the packaging while a second manufacturer 140′ (not shown) may produce and pack the product in the packaging provided by first manufacturer 140. As yet another example, a first manufacturer may produce the product, a second manufacturer may produce the packaging, and a third may package the product within the packaging provided by the second manufacturer. In each case, each manufacturer shall have agreed to manufacture products meeting the threshold level of recyclability established by the system 100. For example, where a threshold level of recyclability is set at 100 percent, each participating manufacturer 140 manufactures all packaging from materials that are completely recyclable at a level of 100 percent.

Manufacturer 140 may receive raw materials from any suitable supplier, provided such materials, once manufactured into packaging, meet the threshold level of recyclability implemented within the closed-loop recycling system 100 (e.g., 100 percent). According to some embodiments, at least a portion of the raw materials provided to the supplier may be recycled materials provided from digital recycling center 150 or other suitable recycler, and may therefore be at least once recycled themselves.

In various embodiments, manufacturer 140 may provide information regarding the recyclability level for each product or item and its associated packaging to merchant 120 such that merchant 120 may maintain accurate information in database 106 regarding each product or item qualifying for inclusion in the closed-loop recycling system 100. Based on the information provided by manufacturer 140, the merchant 120 may include or exclude one or more products from the closed-loop recycling system 100 (e.g. via a flag in a product database).

For example, when the composition of the packaging for a lip balm product container has been changed by manufacturer 140 in a manner that places the container outside of the closed-loop recycling requirements, and merchant 120 receives information concerning this change, the merchant 120 may remove the product from the closed-loop recycling system product database 106 to prevent users wishing to order within the closed-loop recycling system from purchasing the lip balm.

In some other embodiments, manufacturer 140 may provide information regarding the recyclability level for a product or item and its associated packaging directly to the database 106, e.g., via the server 105 or otherwise, without involving merchant 120.

Carrier 130 may be configured to transport items and materials between locations associated with, for example, user 110 (e.g., user's home), merchant 120 (e.g., merchant's warehouse), manufacturer 140 (e.g., manufacturer's warehouse), and digital recycling center 150, among others. For example, carrier 130 may be or include one or more commercial transporters known in the market for delivering items ordered via online shopping interfaces, among others.

Alternatively, or in addition, carrier 130 may include two or more transporters that operate between different participants in the closed-loop recycling system 100. For example, a first carrier 130 may operate between merchant 120, user 110, and digital recycling center 150, while a second carrier 130 may operate between manufacturer 140 and merchant 120. Any combination of carrier operations is intended to fall within the scope of the present disclosure.

Carrier 130 may use any suitable vehicles for performing delivery and pickup operations as desired. For example, carrier 130 may use human operated vehicles, autonomously operated vehicles, and/or semi-autonomous vehicles, among others, for delivery and pickup services. According to some embodiments, autonomous delivery vehicles may be used by carrier 130 at least between merchant 120 and user 110, for example.

Vehicles associated with carrier 130 may further be environmentally friendly vehicles, e.g., low emissions or zero emission vehicles, such as for example, a hybrid vehicle, an electric vehicle, a fuel-cell vehicle, etc.

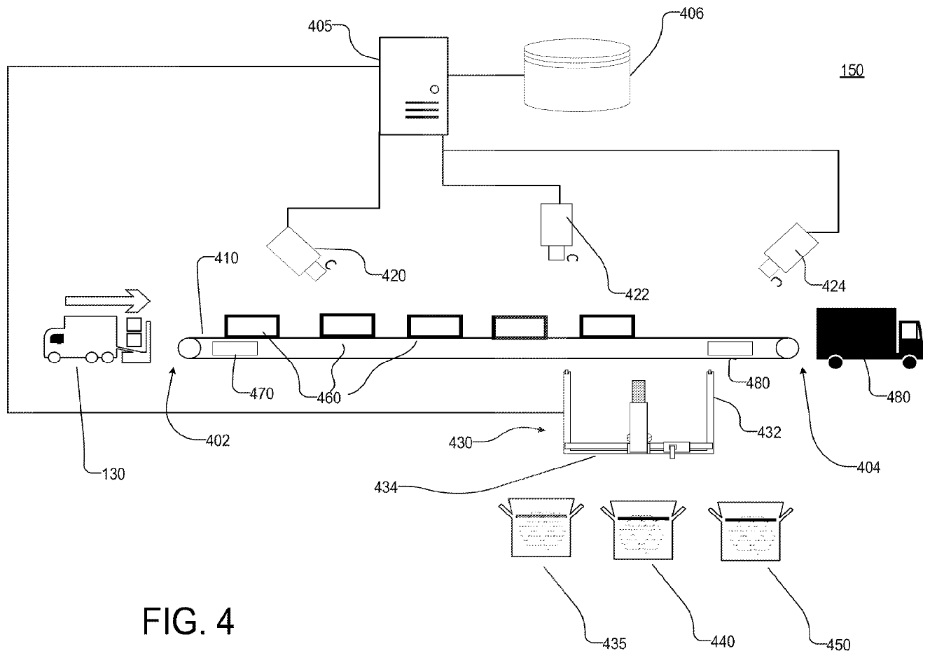

Digital recycling center 150 may be configured for recycling various recyclable materials and may comprise of any number of recycling centers. Each recycling center of digital recycling center 150 may be configured for recycling packaging material existing within the closed-loop recycling system. Digital recycling center, and components thereof, will be described in greater detail below with reference to FIG. 4.

FIG. 1B is a high-level schematic depiction of an alternative closed-loop recycling system 200 according to further embodiments of the present disclosure. FIG. 1B is configured as a “click and collect” type consumer/merchant arrangement, whereby a consumer may place an order and subsequently pick up the products in the order from the merchant directly (e.g., via a curbside pickup service provided by the merchant 120). Thus, a majority of the participants in the embodiment are shared with the embodiment of FIG. 1A, with the exception of the carrier 130. The user 110 acts as both the user and the carrier in the embodiment of FIG. 1B.

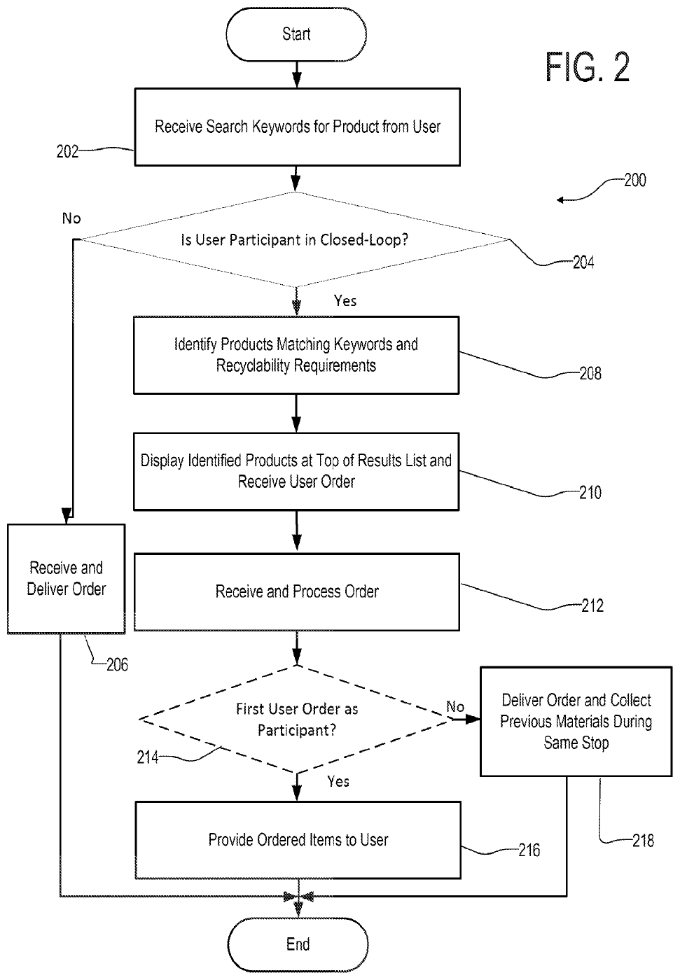

FIG. 2 is a flowchart 200 depicting an exemplary process carried out by one or more computer devices to enable or implement a closed-loop recycling system 100 and/or 200 according to embodiments of the present disclosure.

User 110 may submit one or more search requests (queries), including one or more keywords related to items the user is searching for, to an interface provided by merchant 120, e.g., via or using server 105 (block 202). User 110 may submit the search request via the internet using a computing device, for example, a mobile phone, and the request may be received by server 105. For example, a user searching to buy makeup items may submit a search request including keywords such as, for example, “mascara,” “lipstick,” and/or “nail polish” etc. via an interface provided, for example, by server 105 in order to find relevant makeup products for purchase.

Server 105 may then determine whether user 110 is a participant in a closed-loop recycling program (block 204). For example, server 105 may query the user's profile in database 106, where the database 106 includes user profiles associated with merchant 120, to determine whether a profile for the user exists and/or whether a flag or field indicating participation in the closed-loop recycling program is set in the profile for the user 110 submitting the search request. As noted above, such a flag may be previously set by the user during a profile creation and/or a profile update, or may be set by an administrator following a review of an application submitted by the user to participate in the closed-loop recycling program.

Alternatively, or in addition, a user may be presented, via the interface, with a selection box enabling the user to indicate a desire to search for products (items) falling within or qualifying for the closed-loop recycling system 100 and/or 200, i.e., those products meeting a specific threshold level of recyclability. In such an alternative, the user 110 may be prompted as to whether user 110 would like to join the closed-loop recycling program, and if so, the profile associated with the user 110 in the database 106 may be updated to indicate the user's participation in the closed-loop recycling program. One of skill in the art will recognize that various other methods for determining whether the user 110 wishes to be included in the closed-loop recycling program may be implemented without departing from the scope of the present disclosure.

When it is determined that the user 110 who is submitting a keyword search request does not participate in the closed-loop recycling program (block 204: no), then server 105 may return results, receive an order, and coordinate delivery and/or pickup of the order according to normal practices (block 206), which may or may not include products that qualify for the closed-loop recycling system 100 and/or 200.

When it is determined that a user 110 submitting the keyword search request participates in the closed-loop recycling program (block 204: yes), then server 105 may identify one or more products (items) that both match the received keywords and meet the recyclability requirements of the closed-loop recycling system (block 208). Such products may be referred to as qualifying products or qualifying items because they both match the user's keyword(s) and have packaging that is recyclable to some minimum degree, such as at least 90% recyclable.

For example server 105 may query database 106 for results that are relevant to the one or more keywords and that also have packaging that is recyclable to a predetermined minimum degree or threshold, such as at least 90% recyclable. In some embodiments, the server 105 may attempt to identify products that meet both search criteria first and if any are found, may stop and not identify additional products that do not meet both criteria. Recyclability or the degree of recyclability of items may be identified, for example, using a flag set in database 106 and/or by an express indication of a recyclability level (e.g., percentage) for the packaging associated with the item (e.g., 90%, 95%, 100%, etc.) stored in database 106.

In some other embodiments, in addition to identifying items qualifying for closed-loop recycling system 100 and/or 200, one or more additional items meeting or matching the keywords in the search request received from the user but not qualifying for inclusion within closed-loop recycling system 100 and/or 200 (i.e. not meeting the predetermined level of recyclability) may also be identified and returned by database 106. Such items may be stored in association with an identifier or flag or indicator indicating that they do not meet the predetermined level of recyclability.

At block 210, the server 105 may display or otherwise provide to the user 110 the one or more qualifying products or items (e.g., the qualifying results) identified in block 208. The qualifying results may be displayed or provided in a prioritized manner such that the most recyclable products are listed first or otherwise highlighted to the user 110.

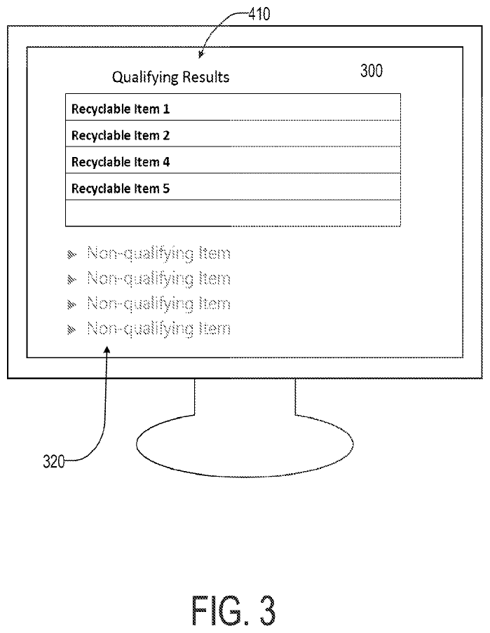

Refer now to FIG. 3, which shows an exemplary user interface 300 for prioritizing search results based on a recyclability level associated with an item. As shown in FIG. 3 one or more tables 310 or the like may be created to highlight qualifying results, with such tables being placed in a more prominent position to draw the user's attention, for example or otherwise prioritize the qualifying results over the non-qualifying results. As shown in this example, non-qualifying items may be displayed in another table 320, for example further below the qualifying results, and/or otherwise with less emphasis or priority, so as not to move the user's attention away from the qualifying results. One of skill will understand that any suitable means for highlighting or prioritizing qualifying products and/or for minimizing or deprioritizing non-qualifying products may be implemented without departing from the scope of the present disclosure.

According to some embodiments, a user may indicate a preference for viewing product items that meet the threshold level of recyclability. For example, a checkbox may be provided to enable the user to indicate a desire to see only search results that qualify for inclusion in the closed-loop recycling system 100 and/or 200, while excluding any non-qualifying items. In such a case, the system may not provide table 320 within interface 300, or the system may provide a link indicating the ability to view non-qualifying products, the link being configured to take a user 110 to a separate page to view non-qualifying results.

Other information (not shown) may also be presented within interface 300, such as, for example, an indication of the quantity of material already delivered to user 110 and/or an indication of a quantity of qualifying material associated with the present order, and an indication of the environmental impact based on the quantity of qualifying material, etc. Such information allows a user 110 to be informed regarding expected future pickup quantities as well as regarding the reduced impact on the environment caused by the user's participation in the closed-loop recycling system 100 and/or 200, among others.

Returning to FIG. 2, once the search results have been provided to user 110 by user interface 300, user 110 may select one or more items (e.g., qualifying and/or nonqualifying) to order from the list of results provided, and the system receives the user's order (block 212). The order placed by user 110 may be processed and completed using techniques known in the art for online sales and will not be described further.

According to embodiments where carrier 130 may perform delivery of an order to a user 110, server 105 may then determine for purposes of fulfillment whether user 110 has previously placed an order while participating in the closed-loop recycling program (block 214). Such a determination may be made based on information stored in database 106, such as, for example, previous order dates (if any) and the date that the user 110 began participating in the closed-loop recycling program. If the order is the first order for the user 110 as a participant in the closed-loop recycling program (block 214: yes), then server 105 may instigate and coordinate fulfillment and delivery of the order (step 216), including the items ordered, in a manner known in the art, e.g., via carrier 130.

If, on the other hand, the order is not the first order for the user 110 (block 214: no), then server 105 may arrange for fulfillment and delivery of the order and may also instigate and coordinate with carrier 130 for collection of packaging associated with one or more selected items from an order that was previously delivered to user 110 (block 218). For example, server 105 may notify carrier 130 to instruct the driver to collect the packaging from previous orders when he or she drops off the current order. Similarly, if not consistently equipped, server 105 may notify carrier 130 that the vehicle that will be used for delivery of the current order to the user 110 should be equipped for pickup of qualifying packaging that was previously delivered. Upon delivery of the items from the order by carrier 130, user 110 may provide previously acquired packaging associated with qualifying items to carrier 130 by any suitable means (e.g., leaving a collection bin 180 outside of the delivery point, personally handing the packaging to a driver of carrier 130, etc.).

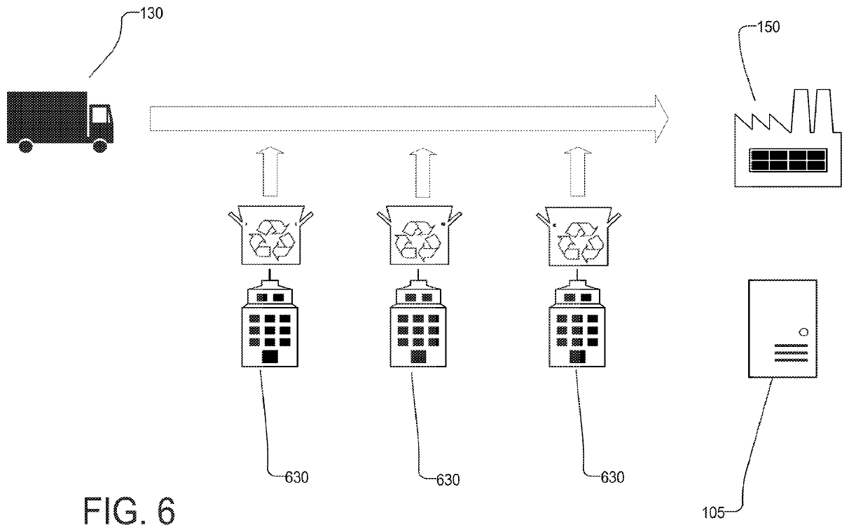

According to embodiments where the user 110 collects items for an order, for example, via curbside pickup, the merchant 120 and user 110 may perform operations according to known methods for “click-and-collect” type order fulfillment. During the stop for collecting the items of the order, or at any other desirable time, the user 110 may then drop off packaging received by the user 110 from a previous or current order, to the merchant 120, a buffer location 630 (shown at FIG. 6), or recycling center 150.

According to some embodiments, server 105 may track the quantity of packaging associated with qualifying items previously ordered by and delivered to user 110 to determine whether a pickup may be desired by user 110 at the time of delivery of a current order. Alternatively or in addition, a user 110 may signal during the ordering process the desire to have previously acquired packaging picked up during delivery of the current order, for example, via a checkbox or other suitable element of the interface 300.

Packaging picked up by carrier 130, and/or dropped off by user 110 may be measured to determine a quantity of material collected to determine, based on the tracking by server 105, (e.g., based on records of items/packaging previously delivered to the user 110), whether the user 110 has returned the proper amount of packaging material (e.g., material corresponding only to qualifying items). For example, where the quantity of packaging material picked up and/or dropped off by a user exceeds the quantity of qualifying material (e.g. by volume, by weight, or by any other suitable measure) recorded by server 105 as having been provided to user 110, it may be assumed that the user has included material that is not intended for recycling within the closed-loop recycling system 100 and/or 200. The server 105 may then request from user 110 information regarding the measured quantity of packaging material that was collected or received from user 110. For example, server 105 in response to a carrier notification of excess material, may send the user 110 a notification via, for example, SMS, email, telephone, etc. indicating that user 110 should log into server 105 for purposes of providing information related to a recent packaging material pickup.

According to some embodiments a user 110 may exceed the quantity of packaging material tracked or recorded by server 105 provided such excess does not go beyond a predetermined threshold (e.g. 5 percent, 10 percent, 15 percent, etc.) without receiving a notification to provide information. In such instances, the number of occurrences may be tracked for each user 110, and notification provided to each user 110 who exceeds the tracked quantity without exceeding the threshold if this occurs for more than a predetermined number of collections (e.g., on more than 5 collections).

If a user 110 exceeds the predetermined threshold of packaging for greater than a predetermined number of collections and fails to provide information regarding the excess in response to notifications sent to the user 110, then the system may remove that user 110 from the closed-loop recycling program, for example, for a predetermined amount of time (e.g. one month), or even indefinitely. After such a removal, user 110 may be prohibited from participating in the closed-loop recycling program, and database 106 may be updated to reflect the fact that that user 110 is not presently participating in the program, thereby eliminating that user's ability to specifically search for products qualifying for inclusion within the closed-loop recycling program, and to schedule or participate in future packaging material collection.

In various embodiments, a user 110 may be able to use the system to review information related to participation in the closed-loop recycling program. For example, tracked quantities of packaging material sent to or picked up by the user 110, measured quantities of material picked up from user 110, actual recycled material measurements for a user 110, and/or an environmental impact metric based on a difference between these two quantities, among others, may all be reviewable by user 110 by accessing a profile interface from server 105 and/or during an order process from merchant 120 (e.g., by viewing a user profile). For example, a user may log into server 105 and request information regarding participation details within closed-loop recycling system 100 and/or 200. Upon making such a request a user may be presented with information via interface 300, where the information is related to tracked quantities of material, picked up quantities of material, actual recycled material amounts, environmental impact, and according to some embodiments, promotional offers for participating in the system (e.g. coupons, early-bird specials, early private sales, etc.).

According to some embodiments, display of such “incentivizing information” may be provided to the user 110 in a manner further encouraging participation in the closed-loop recycling program, as well as to instill a sense of contribution to the user 110. For example, the information displayed to the user 110 may compare (e.g., statistically and maintaining privacy) the user to one or more groups of other users using various features of the display to draw the user's attention to their respective accomplishments. Additionally, promotional offers provided to the user may be targeted to the user to further encourage participation in the closed-loop recycling system based on past order history, and other intelligent marketing techniques (e.g., cookie based tracking to determined user interest). Still further, a user may be provided with awards and public recognition for reaching certain recycling milestones (e.g., each 50 kg of recycled packaging, an award is publicly added to a user profile).

After collecting the packaging material from user 110, carrier 130 or any other suitable transporter (e.g., a transporter managed by recycling center 150) may deliver the collected qualifying packaging materials to digital recycling center 150. Alternatively, the qualifying packaging materials may be delivered to a buffer location 630 (see FIG. 6), the buffer location 630 being remotely located from digital recycling center 150. An illustrative buffer location 630 may be present for example, at or near one or more third-party merchant sites, and may include one or more collection receptacles configured to allow placement of recyclable materials destined for recycling center 150 therein, for example, for collection at a later time by, for example, a representative of digital recycling center 150. According to such embodiments, digital recycling center 150 may receive a notification when collected packaging materials at the buffer location 630 is approaching or has exceeded a predetermined value corresponding to the capacity of one or more collection receptacles located at the buffer location 630. Such a determination may be made based on at least the tracking information collected by server 105 and/or sensor information associated with the one or more collection receptacles (e.g. weight sensors, image sensors, level sensors, etc.), the sensor information being sent to server 105, for example.

FIG. 4 is a schematic diagram highlighting features of a digital recycling center 150 according to embodiments of the present disclosure. Digital recycling center 150 may be configured to receive recyclable packaging materials 460 picked up from a user 110, track the quantity of the receive materials, sort such materials, and to handle nonrecyclable materials introduced into the system. Digital recycling center 150 may comprise a server 405, an object database 406, one or more conveyors 410, an object identification system including optical capture devices 420-424 (e.g., cameras), an object removal system 430, and one or more receptacles 435, 440, 450.

Server 405 may be implemented by any suitable computing device similar to server 105. According to some embodiments, server 405 and server 105 may be present on the same computing device. Alternatively, server 405 and server 105 may be separate servers with communication links between the two.

In some embodiments, server 405 may be, or may implement at least part of, the object identification system and may be configured to receive image data from one or more optical capture devices 420-424 and to process those images according to embodiments of the present disclosure. For example, server 405 may be configured to perform object recognition as part of the object identification system, as well as flow monitoring for conveyor 410, flow control for conveyor 410, and notification services, among others.

Server 405 may be communicatively linked to object database 406 to enable server 405 to obtain information related to objects delivered to digital recycling center 150 (e.g., qualifying and/or non-qualifying packaging materials from items included in closed-loop recycling system 100 and/or 200). Server 405 may implement various modules for purposes of executing functions according to embodiments of the present disclosure. For example server 405 may implement a neural network for purposes of performing the object recognition on imaging data received from optical capture devices 420-424, among others, to identify objects 460 on conveyor 410.

Server 405 may also include modules for monitoring an inflow of packaging materials, a module for monitoring an outflow of packaging materials, and a module for sending notifications to, for example, server 105, merchant 120, carrier 130, manufacturer 140, and/or user 110, among others.

Object database 406 may store information regarding objects (e.g., packaging) included in closed-loop recycling system 100 and/or 200, for example, shape, color, size, text, trademark markings, etc. Object database 406 may be any suitable database system similar to database 106, for example, enabling storage of images, as well as information related to objects present in the images. According to some embodiments, database 106 and database 406 may be implemented as one single database system or as a replicated type database system.

Conveyor 410 may be configured to convey a plurality of objects 460 (e.g., packaging materials) from a loading point 402 to an exit point 404, and may be any suitable conveyance mechanism known in the art. For example, conveyor 410 may be a typical conveyor belt having a weight rating and feed rate suitable for conveying packaging objects 460 that are delivered by a carrier 130 from a receiving point (i.e., loading point 402 to a waste removal point (i.e., exit point 404), where any remaining packaging objects are collected by a waste removal entity 480.

According some embodiments, conveyor 410 may be configured to enhance and/or facilitate the object identification system associated with the one or more optical capture devices 420-424. For example, a belt associated with conveyor 410 and on which packaging-material objects 460 may be conveyed, may include a reflective background or other background configured to enhance and enable high contrast between the belt and the packaging materials 460.

The object identification system may comprise modules of server 405 as well as one or more optical capture devices 420, 422, 424 that may be implemented for monitoring, tracking, imaging, and/or object identification of packaging materials 460 transported on conveyor 410. Optical capture devices 420, 422, 424 may be any suitable digital image capture device having communicative functionalities (e.g., via ethernet, WiFi, etc.) such as, for example, a charged coupled device (CCD) camera, a complementary metal oxide semiconductor (CMOS) camera, etc. The one or more optical capture devices may be configured to send image information regarding objects 460, (for example, images representing the color, shape, size, and/or markings, etc. of the packaging objects 460), present on conveyor 410 to server 405 for evaluation.

Optical capture devices 420, 422, 424 may further be configured to capture images that are used to calculate or measure a quantity of inflow packaging material and a quantity of outflow packaging material on conveyor 410. According to some examples, a first optical capture device 420 may be positioned at or near loading point 402 of conveyor 410 and/or a scale 470 incorporated within conveyor 410 at or near loading point 402 to record, measure, and/or monitor inflow materials delivered to digital recycling center 150 by carrier 130 or other suitable delivery agent, and provide information regarding inflow to server 405. A second optical capture device 424 may be positioned, for example, downstream of object removal system 430 in the flow direction of conveyor 410 (e.g., at or near exit point 404) and/or a second scale 480 incorporated within conveyor 410 at or near exit point 404 may measure a quantity of outflow material that is left after the object removal system 430 has removed selected, identified objects, and transmit information related thereto to server 405. A third optical capture device 422 may be positioned at any suitable location along conveyor 410, and may be aimed such that the field of view of the optical capture device 422 captures images of each packaging object 460 present on conveyor 410. Optical capture device 422 may be configured to transmit the captured images to server 405 for evaluation. Other configurations for the one or more optical capture devices are also contemplated, for example, a single camera configured to monitor and capture images.

Notably, each image captured by optical capture device 422 may comprise one or more objects 460 that present on conveyor 410 within the field of view of optical capture device 422. The number of objects 460 that may be captured per unit time by optical capture device 422 may be determined as a function of the speed and capabilities of the optical capture device 422, network latency, server 405 processing power, etc.

Server 405 may be configured to receive image data from the one or more optical capture devices 420-424 and to perform object recognition processing on packaging objects 460 recorded or detected in the image data. For example, server 405 may be configured to perform a comparison between the detected objects 460 and the objects present in database 406 (e.g., packaging objects qualifying for inclusion in the closed loop recycling system 100). For example, the size, shape, color, text, and/or markings for each object 460 in an image may be compared with images of packaging stored in the object database 406, and upon detecting a match, the server 405 may determine an object 460's composition and recyclability level based on composition and recyclability information stored in the object database 406 in association with the matching image.

According to further examples, a neural network operating on server 405 may be trained to recognize objects detected in the image data. After training, the neural network can identify packaging objects that are largely unaltered, and also identify objects that have been damaged or otherwise transformed or altered, (e.g., crumpled, twisted, cut, torn, etc.), based on whatever object characteristics are identifiable in the image transmitted by the optical capture device(s) 422. In such examples, the neural network may be trained based on characteristic inflows of packaging materials and those objects remaining on the conveyor 410 post (after) the object removal system 430, which is typically those objects that don't qualify for recycling in the closed-loop recycling system and qualifying objects that were not identified as such for some reason, such as because they were damaged or altered to such a large extent that the system could not recognize or identify them.

After identifying one or more packaging object 460 that is included in the closed-loop recycling system, the object identification system (e.g., server 105) may be configured to issue one or more instructions to various components of digital recycling center 150. For example, instructions may be issued for slowing or stopping conveyor 410, for navigating or positioning components of object removal system 430, and for removing the identified objects 460 from conveyor 410, for example. Such instructions may be issued via communicative connections among the components within the center, e.g., via WiFi and/or ethernet.

In various embodiments, object removal system 430 may be movable and may comprise one or more robotic elements 432, 434 (e.g., wheels, caterpillar tracks, motors, robotic arms, robotic grippers, etc.) configured to move object removal system 430, and/or to grip, push, pull, and/or remove one or more identified objects 460 from conveyor 410. For example, object removal system may comprise a mobile unit 434 in communication with server 405 (e.g., via WiFi) configured to move object removal system 430 back and forth alongside conveyor 410 to align itself with an object 460 to be removed from conveyor 410 based on instruction from the object identification system following identification of the object 460 to be removed. Such movement may be accomplished using the motors and rolling stock of mobile unit 434 based on communication from server 405 indicating a location to which mobile unit 434 should navigate along conveyor 410.

One or more robotic arms and/or robotic grippers 432 associated with object removal system 430 may be configured to grip, push, pull, and/or move an object 460 from conveyor 410 into a receptacle 435-450 based on an instruction from server 405 and/or the object identification system. For example, the object removal system 430 may have two arms including grippers 432 at a distal portion of each arm configured to grip one or more objects based on a received instruction.

One or more receptacles 435, 440, 450 may be configured to receive one or more objects 460 removed from conveyor 410 by object removal system 430. For example, each receptacle may be configured to receive an object 460 based on the composition of object 460. In other words, for example, a first receptacle 435 may be configured to receive metal objects, a second receptacle 440 may be configured to receive plastic objects, and a third receptacle 450 may be configured to receive paper and cardboard objects. One of ordinary skill will recognize that other configurations and more or fewer receptacles may be implemented as desired without departing from the scope of the present disclosure.

One of ordinary skill will also recognize that the object removal system 430 could be equipped with an onboard optical capture device(s) in addition to or in place of one or more of the optical capture devices 420-424 shown. In such embodiments, the object removal system 430 may maneuver itself and may grip, push, pull, and/or remove one or more identified objects 460 from conveyor 410 using images and information from its onboard optical capture device.

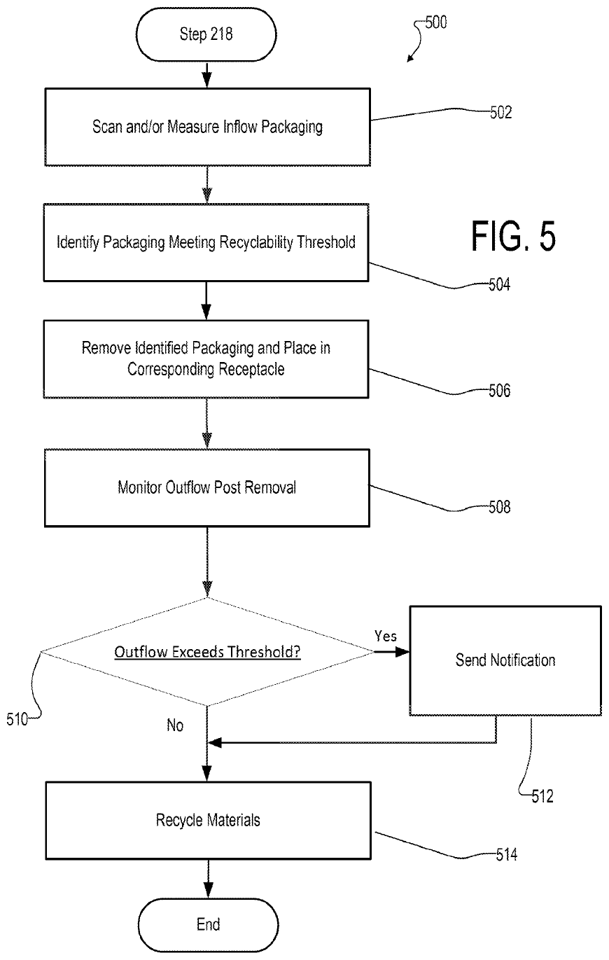

FIG. 5 is a flowchart depicting an exemplary process 500 carried out by the hardware components of the digital recycling center 150 of FIG. 4. According to embodiments of the present disclosure, any suitable transporter (e.g., user 110, carrier 130, etc.) may deliver used packaging objects 460 obtained from one or more users 110 participating in closed-loop recycling system 100 and/or 200, to digital recycling center 150. Carrier 130 may unload the packaging materials onto conveyor 410 and the materials may be scanned by optical capture device 420 and/or weighed, for example, to measure the inflow of packaging to digital recycling center 150 (block 502). According to some embodiments the used packaging 460 may be both weighed and scanned to measure for volume and weight of the used packaging inflow, e.g., via a scale and optical capture device 420. Information associated with the weight and/or scanned inflow data may then be transmitted to server 405 for processing, storing, and tracking.

As conveyor 410 moves the packaging from the loading point 402 towards the exit point 404, optical capture device 422 may capture one or more images of objects 460 on conveyer 410, and in cooperation with server 405 and/or database 406, identify packaging objects that meet specific recyclability threshold requirements (block 504). For example, optical capture device 422 may capture one or more images of the objects 460 and send the image data associated with the images to server 405 for processing.

Upon receipt of images from optical capture device 422, server 405 may perform object recognition 460 on the image, for example, using database comparisons and/or image segmentation by a neural network on server 405, in order to identify packaging known to meet the recyclability threshold (block 504).

Upon identifying an object 460 on conveyer 410, object identification system may issue an instruction intended for object removal system 430. The instruction issued by the object identification system may include any suitable information the enables the object removal system 430 to remove an identified object and to place it in a corresponding receptacle 435-450, e.g., an appropriate receptacle 435-450 that is designated to hold the type of material(s) that composes the object. For example, such information may include location information (e.g., where on conveyor 410), composition information, corresponding receptacle information, etc.

Thus, an instruction indicating a location and/or description of the object 460 on conveyer 410 and a corresponding, appropriate receptacle 435-450 may be issued upon object identification such that object removal system 430 may, in some embodiments, navigate to the identified object 460, remove the object 460 from conveyor 410, and place the object in a corresponding receptacle 435-450 based on for example, the composition of the object 460 (block 506). For example, in some embodiments, the object removal system 430 may navigate using one or more motors and rolling stock, and then use robotic elements 432 and/or 434 to grip or manipulate the identified object 460 to remove the object 460 from conveyor belt 410. The object 460 may then be placed in a corresponding receptacle 435-450 by object removal system 430, navigating in a similar manner based on the instruction. In some other embodiments, the object removal system 430 may be stationary and may wait until the conveyor 410 brings the identified packaging object 460 in front of it before moving the object 460 into an appropriate, corresponding receptacle 435-450.

Object removal system 430 may proceed in this manner repeatedly, removing qualifying objects from conveyor 410 while ignoring unidentified objects (e.g., non-qualifying objects). Unidentified objects 460 remaining on conveyer 410 until they move past the object removal system 430, and such unidentified objects 460 may be tracked and measured to determine the quantity of unidentified packaging materials remaining on the conveyor 410, which may be referred to as outflow material (block 508). Any such objects may be considered as not qualifying, i.e., not meeting the desired threshold level of recyclability, and/or may be considered unidentifiable, and may proceed to endpoint 404 where waste handler 480 may take them to an appropriate disposal location (e.g., landfill, incinerator, etc.). In some embodiments, images of the outflow packaging objects that remain on the conveyer 410 at the endpoint 404 may be used to further train the neural network that performs image recognition processes within digital recycling center 150.

Server 405 may then determine the difference between inflow and outflow for purposes of evaluating, among others, waste removal needs associated with waste hauler 480 (block 510). If the difference between an inflow quantity and an outflow quantity exceed a predetermined threshold value (e.g. greater than 10 percent of the inflow is outflowing) (block 510: yes) a notification may be sent by server 405 to an operator of digital recycling center 150 and/or other suitable parties (e.g., user 110, manufacturer 140, etc.) (block 512). Such a notification may be used, for example, by an operator of digital recycling center 150 to implement a contingency plan configured to mitigate the outflow of apparently non-recyclable waste. According to such an example, an operator may stop processing packaging on conveyor 410 to inspect the system to ensure proper functioning, for example, where identification errors (e.g., misidentification or false negatives) are occurring.

Objects placed in corresponding (e.g., material sorted) receptacles may then be recycled according to their composition and methods known in the art (block 514). Because the objects have been automatically placed in an appropriate corresponding receptacle, the receptacle's contents being based on the composition of the object, recycling may be facilitated.

FIG. 6 is another schematic diagram highlighting alternative features of a closed-loop recycling system according to further embodiments of the present disclosure. According to some embodiments, one or more buffer locations 630 may be located remotely from a digital recycling center 150. For example, one or more third-party merchant sites, public spaces, etc. and may be provided with one or more receptacles, e.g., smart receptacles configured to receive used, recyclable packaging materials from users 110, for example in a collective manner, and to transmit fill level signals, among others. Server 105 may be in communication with each buffer location 630 to monitor the inflow of used packaging materials at each location 630 based on, for example, signals sent by the smart receptacles and/or communications from a representative at the location 630.

Upon determining that a quantity of used packaging materials is approaching or has reached a predetermined quantity, digital recycling center 150 and/or another suitable entity may request that carrier 132 collect the used packaging material from a specific buffer location 630.

Any suitable transporter, (e.g. carrier 130) may then transport the collected packaging materials to digital recycling center 150 for sorting and recycling as described herein.

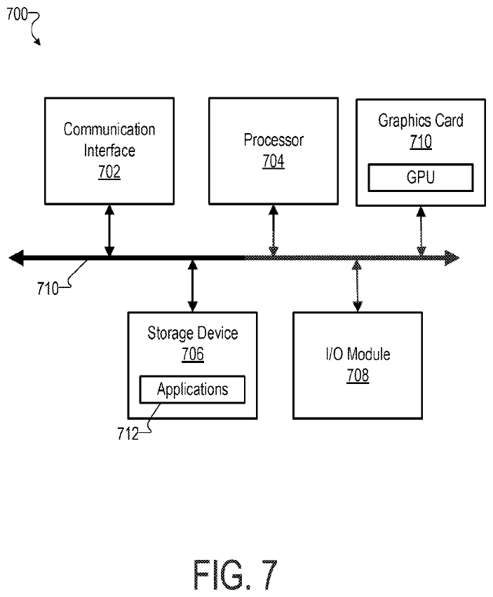

FIG. 7 illustrates an exemplary computing device 700 that may be specifically configured to perform one or more of the processes described herein based on instructions stored in a non-transitory computer-readable medium communicatively coupled to a processor. As shown in FIG. 7, computing device 700 may include a communication interface 702, a processor 704, a storage device 706, and an input/output (“I/O”) module 708 communicatively connected via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data or interpreting, executing, and/or directing execution of one or more of the instructions, processes, and/or operations described herein. Processor 704 may direct execution of operations in accordance with one or more applications 712 or other computer-executable instructions such as may be stored in storage device 706 or another computer-readable medium.

Storage device 706 may include one or more data storage media, devices, or configurations and may employ any type, form, and combination of data storage media and/or device. For example, storage device 706 may include, but is not limited to, a hard drive, network drive, flash drive, magnetic disc, optical disc, RAM, dynamic RAM, other non-volatile and/or volatile data storage units, or a combination or sub-combination thereof. Electronic data or information, including data and information described herein, may be temporarily and/or permanently stored in storage device 706. For example, data representative of one or more executable applications 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. One or more I/O modules may be used to receive input. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation.

A consumer participating in a closed-loop recycling system 100 and/or 200 according to embodiments of the present disclosure knows that all materials included in the closed-loop recycling system meet a threshold level of recyclability. Therefore, consumer confusion is eliminated and the consumer may return all of the packaging material from a previous order to a carrier 130 during delivery of a subsequent order and be assured that the packaging material will be recycled.

Further, because a user 110 may actively track and view their “contribution” to the recycling effort in terms of quantities and environmental impact, the users may be incentivized to participate even more, and at a minimum can feel a sense of reward and accomplishment for their contributions.

Still further, because all packaging material from items included in the closed-loop recycling system may be recycled based on their meeting of the threshold level of recyclability, the amount of outflow waste from digital recycling center may be significantly reduced and/or eliminated.

Moreover, the automated systems according to embodiments of the present disclosure may significantly reduce the amount of man-hours implemented at a recycling center for sorting recyclable material and separating such recyclable material from nonrecyclable waste. Therefore a digital recycling center operating according to embodiments of the present disclosure may operate with a higher profit margin than a conventional recycling center.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

A system comprises a processor; and a non-transitory computer-readable medium communicatively coupled to the processor and storing instructions configured to cause the processor to perform operations comprising: receiving, from a user, a search request comprising one or more keywords related to a desired item; determining that the user is a participant in a closed-loop recycling program based on a user setting; identifying, based on the determination and the keywords, one or more item results, at least one qualifying result of the one or more item results having a packaging meeting a predetermined level of recyclability; and providing to the user in a prioritized manner, the at least one qualifying result.

The system according to paragraph [00137], comprising: receiving, from the user, a first order comprising one or more selected items from the at least one qualifying result; and coordinating receiving of the packaging associated with the one or more selected items from the user.

The system according to paragraph [00137], wherein the receiving of the packaging is performed during a delivery of a second order received from the user.

The system according to paragraph [00137], wherein the predetermined level of recyclability ranges between 80 and 100 percent.

The system according to paragraph [00137], wherein the instructions further cause the processor to perform operations comprising: tracking a quantity of recyclable packaging associated with the one or more selected items delivered to the user; measuring a quantity of material collected during delivery of the second order; and when the measured quantity of material exceeds the quantity of recyclable packaging delivered to the user by a predetermined threshold, requesting information regarding the measured quantity from the user.

The system according to paragraph [00141], wherein the instructions further cause the processor to perform operations comprising: when a user exceeds the predetermined threshold over greater than a predetermined number of collections and/or when no information is received in response to the request, prohibiting the user from participating in the closed-loop recycling program for a predetermined amount of time.

The system according to paragraph [00137], wherein the instructions further cause the processor to perform operations comprising: enabling a user to view exclusively item results having packaging meeting the predetermined level of recyclability.

The system according to paragraph [00141], wherein the instructions further cause the processor to perform operations comprising: providing to the user an information indicating at least one of the tracked quantity, the measured quantity, a recycled quantity, and an environmental impact based on the tracked quantity and/or the measured quantity.

The system according to paragraph [00141], wherein the instructions further cause the processor to perform operations comprising: matching the user with one or more incentives for participating in the closed-loop recycling program based at least on the measured quantity of material.

The system according to paragraph [00145], wherein the incentives are selected from at least one of a monetary incentive, a priority incentive, and a recognition incentive.

A digital recycling center management system for a recycling center, comprises: a conveyor configured to convey a plurality of objects from a loading point to an exit point, at least a portion of the plurality of objects comprising packaging having a predetermined level of recyclability and having been collected from a consumer; an object identification system comprising at least one optical capture device, the object identification system being configured to identify each object of the plurality of objects based on physical characteristics of each object and to issue an instruction based on the identification; an object removal system configured to remove identified objects from the conveyor and to place a removed object in a corresponding receptacle based on the instruction from the object identification system; an inflow monitor configured to measure an inflow of packaging materials on the conveyor; and an outflow monitor configured to measure a quantity of packaging materials remaining on the conveyor after object removal is completed, wherein the object identification system is configured to compare one or more captured images of an object to one or more images in a recyclable object image database and determine the issued instruction according to the identified object.

The system according to paragraph [00147], wherein the object identification system further comprises a neural network component.

The system according to paragraph [00148], wherein the neural network component of the object identification system is trained based on at least one of the inflow of packaging materials and the quantity of packaging materials remaining on the conveyor after object removal is completed.

The system according to paragraph [00148], wherein the corresponding receptacle corresponds to at least one of a material category and a material recyclability level.

The system according to paragraph [00148], wherein the outflow monitor is configured to issue a notification when the measured quantity exceeds a predetermined value.

The system according to paragraph [00151], wherein upon receiving the notification, the object removal system is configured to operate under a contingency plan mitigating an amount of outflow waste.

The system according to paragraph [00148], further comprising: a buffer located remotely from the recycling center comprising: a collection receptacle configured to collect and track a second inflow of packaging materials; a processor; and a non-transitory computer-readable medium communicatively coupled to the processor and storing instructions configured to cause the processor to perform operations comprising: notifying the digital recycling center management system when a quantity of the collected packaging materials at the buffer is approaching and/or has exceeded a predetermined value.

The system according to paragraph [00151], wherein the buffer is located at a third-party merchant site.

A method for facilitating closed-loop recycling, comprises: receiving, from a user, a search request comprising one or more keywords related to a desired item; determining that the user is a participant in a closed-loop recycling program; identifying, based on the determination and the keywords, one or more item results, at least one qualifying result of the one or more item results having a packaging meeting a predetermined level of recyclability; providing to the user in a prioritized manner, the at least one qualifying result; receiving, from the user, a first order comprising one or more selected items from the at least one qualifying result; collecting the packaging associated with the one or more selected items; identifying, by at least one optical capture device, a recyclable packaging from the collected packaging based on at least one of a shape and a logo present in an image, wherein the identifying comprises comparing one or more captured images of recyclable packaging to one or more images in a recyclable object image database; removing, by a removal system, the identified recyclable packaging and placing the identified recyclable packaging in a corresponding receptacle based on the identifying; and recycling the contents of the corresponding receptacle in a manner suitable for a category of the identified recyclable packaging.

The method according to paragraph [00155], wherein the predetermined level of recyclability is 100 percent.

The method according to paragraph [00156], wherein the category is based on at least a material from which the identified recyclable packaging is fabricated.

It is intended that the specification and examples be considered as exemplary only, with a true scope of the disclosure being indicated by the following claims.

1. A system comprising:
a processor; and
a non-transitory computer-readable medium communicatively coupled to the processor and storing instructions configured to cause the processor to perform operations comprising:
receiving, from a user, a search request comprising one or more keywords related to a desired item;
determining that the user is a participant in a closed-loop recycling program based on a user setting;
identifying, based on the determination and the keywords, one or more item results, at least one qualifying result of the one or more item results having a packaging meeting a predetermined level of recyclability; and
providing to the user in a prioritized manner, the at least one qualifying result.

2. The system according to claim 1, comprising:
receiving, from the user, a first order comprising one or more selected items from the at least one qualifying result; and
coordinating receiving of the packaging associated with the one or more selected items from the user.

3. The system according to claim 1, wherein the receiving of the packaging is performed during a delivery of a second order received from the user.

4. The system according to claim 1, wherein the predetermined level of recyclability ranges between 80 and 100 percent.

5. The system according to claim 1, wherein the instructions further cause the processor to perform operations comprising:
tracking a quantity of recyclable packaging associated with the one or more selected items delivered to the user;
measuring a quantity of material collected during delivery of the second order; and
when the measured quantity of material exceeds the quantity of recyclable packaging delivered to the user by a predetermined threshold, requesting information regarding the measured quantity from the user.

6. The system according to claim 5, wherein the instructions further cause the processor to perform operations comprising:
when a user exceeds the predetermined threshold over greater than a predetermined number of collections and/or when no information is received in response to the request, prohibiting the user from participating in the closed-loop recycling program for a predetermined amount of time.

7. The system according to claim 1, wherein the instructions further cause the processor to perform operations comprising:
enabling a user to view exclusively item results having packaging meeting the predetermined level of recyclability.

8. The system according to claim 5, wherein the instructions further cause the processor to perform operations comprising:
providing to the user an information indicating at least one of the tracked quantity, the measured quantity, a recycled quantity, and an environmental impact based on the tracked quantity and/or the measured quantity.

9. The system according to claim 5, wherein the instructions further cause the processor to perform operations comprising:
matching the user with one or more incentives for participating in the closed-loop recycling program based at least on the measured quantity of material;
wherein the incentives are selected from at least one of a monetary incentive, a priority incentive, and a recognition incentive.

10. (canceled)

11. A digital recycling center management system for a recycling center, comprising:
a conveyor configured to convey a plurality of objects from a loading point to an exit point, at least a portion of the plurality of objects comprising packaging having a predetermined level of recyclability and having been collected from a consumer;
an object identification system comprising at least one optical capture device, the object identification system being configured to identify each object of the plurality of objects based on physical characteristics of each object and to issue an instruction based on the identification;
an object removal system configured to remove identified objects from the conveyor and to place a removed object in a corresponding receptacle based on the instruction from the object identification system;
an inflow monitor configured to measure an inflow of packaging materials on the conveyor; and
an outflow monitor configured to measure a quantity of packaging materials remaining on the conveyor after object removal is completed,
wherein the object identification system is configured to compare one or more captured images of an object to one or more images in a recyclable object image database and determine the issued instruction according to the identified object.

12. The system according to claim 11, wherein the object identification system further comprises a neural network component.

13. The system according to claim 12, wherein the neural network component of the object identification system is trained based on at least one of the inflow of packaging materials and the quantity of packaging materials remaining on the conveyor after object removal is completed.

14. The system according to claim 11, wherein the corresponding receptacle corresponds to at least one of a material category and a material recyclability level.

15. The system according to claim 11, wherein the outflow monitor is configured to issue a notification when the measured quantity exceeds a predetermined value.

16. The system according to claim 15, wherein upon receiving the notification, the object removal system is configured to operate under a contingency plan mitigating an amount of outflow waste.

17. The system according to claim 11, further comprising:
a buffer located remotely from the recycling center comprising:
a collection receptacle configured to collect and track a second inflow of packaging materials;
a processor; and
a non-transitory computer-readable medium communicatively coupled to the processor and storing instructions configured to cause the processor to perform operations comprising:
notifying the digital recycling center management system when a quantity of the collected packaging materials at the buffer is approaching and/or has exceeded a predetermined value.

18. The system according to claim 15, wherein the buffer is located at a third-party merchant site.

19. A method for facilitating closed-loop recycling, comprising:
receiving, from a user, a search request comprising one or more keywords related to a desired item;
determining that the user is a participant in a closed-loop recycling program;
identifying, based on the determination and the keywords, one or more item results, at least one qualifying result of the one or more item results having a packaging meeting a predetermined level of recyclability;
providing to the user in a prioritized manner, the at least one qualifying result;
receiving, from the user, a first order comprising one or more selected items from the at least one qualifying result;
collecting the packaging associated with the one or more selected items;
identifying, by at least one optical capture device, a recyclable packaging from the collected packaging based on at least one of a shape and a logo present in an image, wherein the identifying comprises comparing one or more captured images of recyclable packaging to one or more images in a recyclable object image database;
removing, by a removal system, the identified recyclable packaging and placing the identified recyclable packaging in a corresponding receptacle based on the identifying; and
recycling the contents of the corresponding receptacle in a manner suitable for a category of the identified recyclable packaging.

20. The method according to claim 19, wherein the predetermined level of recyclability is 100 percent.

21. The method according to claim 19, wherein the category is based on at least a material from which the identified recyclable packaging is fabricated.
